(19) United States
(12) Patent Application Publication
(10) Pub. No.: US 2008/0244909 A1
(43) Pub. Date: Oct. 9, 2008

(54) Razor counter and ejector

(75) Inventors: Yvette Golan, Houston, TX (US); Wyley Gipson Kitzmiller, El Paso, TX (US)

Correspondence Address: World Innova Corp.;Two Allen Center, Suite 1600, 1200 Smith Street, Houston, TX, 77002, US

(73) Assignee: World Innova Corp., Houston, TX (US)

(21) Appl. No.: 11/784,676

(22) Filed: Apr. 9, 2007

(51) Int. Cl. B26B 21/00

(52) U.S. Cl. 30/47

(57) ABSTRACT

In a method and system for shaving a razor system includes a razor, a receptacle, a counter, and an ejector. The razor includes a razor handle and a razor head, the razor head being detachably coupled to the razor handle by a sliding latch. The receptacle removably houses the razor. The counter cumulatively counts each instance of a removal of the razor from the receptacle. The counter includes a comparator to compare the cumulative count to a preset count. The ejector is operable to disengage the sliding latch, thereby causing the razor head to detach from the razor handle. The ejector disengages the sliding latch in response to the cumulative count being equal to the preset count.

### BACKGROUND

This invention generally refers to a safety razor, and more particularly to tools and techniques to assist a user in determining an effectiveness of the safety razor after multiple uses.

A razor or shaver includes at least one safety razor blade having a sharp cutting edge. The effectiveness of the cutting edge generally diminishes with each use. The user's experience of having a clean and comfortable shave associated with a new blade also diminishes with each use. An acceptable level of user experience is personal and may vary individually based on unique personal preferences. It is a common practice to replace the dull blade with a new blade to restore the user experience associated with a new blade. The decision to replace the dull razor blade is generally based on factors such as blade technology, manufacturer recommendations, previous experience, cost, and personal factors.

Various techniques to count each use of a blade have been disclosed in the prior art. However, such techniques have relied on the user manually counting the number of uses of the blade. More recently, techniques for counting each use of the blade are activated by a user action such as a user activating an on or off switch for an electric shaver, or a user inserting or removing a razor from a razor holder. However, such techniques for counting each use of a blade often rely on the user monitoring the counter. Additionally, such techniques may not be customizable for each user to optimize the user experience. That is, the user is typically not empowered to personalize, adapt, or adjust desired features or attributes of a safety razor to match personal preferences.

### SUMMARY

Applicant recognizes an existing need for an improved safety razor; and the need for improved tools and techniques that are customizable by each user. It would be desirable to empower the user by enabling the user to define or configure a desired number of uses of a razor blade or define preferred time duration before blade replacement or both. Additionally, it would be desirable for the improved safety razor to automatically count each use of the blade without relying on the user to monitor the counter. Furthermore, it would be desirable for the improved safety razor to automatically eject the used razor blade after a configured number of uses or after expiration of the preferred time duration, in accordance with the user defined criteria. Accordingly, it would be desirable to provide an improved customizable safety razor, absent the disadvantages found in the prior techniques discussed above.

The foregoing need is addressed by the teachings of the present disclosure, which relates to a system and method for shaving. According to one embodiment, in a method and system for shaving a razor system includes a razor, a receptacle, a counter, and an ejector. The razor includes a razor handle and a razor head, the razor head being detachably coupled to the razor handle by a sliding latch. The receptacle removably houses the razor. The counter cumulatively counts each instance of a removal of the razor from the receptacle. The counter includes a comparator to compare the cumulative count to a preset count. The ejector is operable to disengage the sliding latch, thereby causing the razor head to detach from the razor handle. The ejector disengages the sliding latch in response to the cumulative count being equal to the preset count.

In one aspect, a method for shaving includes configuring a razor system having a razor, a counter, an ejector, and a receptacle. The razor includes a razor head detachably coupled to a razor handle by a sliding latch. The ejector is operable to disengage the sliding latch and the receptacle removably houses the razor. Configuration of the razor system includes defining a desirable number of uses of the razor head. The razor is removed from the receptacle to perform the shaving. Each use of the razor is counted by the counter. The razor head is ejected from the razor handle by disengaging the sliding latch. The ejecting is performed by the ejector when a count of the number of uses of the razor is equal to the desirable number of uses of the razor head.

Several advantages are achieved by the method and system according to the illustrative embodiments presented herein. The embodiments advantageously provide an improved shaving system that is capable of empowering a user to define desirable number of shaves for each blade before it is replaced. The improved razor system provides automatic tracking for the number of uses of the razor blade. In addition, the razor system also provides automatic ejection of the razor blade when the number of uses of the razor blade is equal to the desirable number of shaves for the razor blade. The razor system thus automatically ensures an acceptable level of sharpness of the razor blade, thereby improving the users shaving experience.

### BRIEF DESCRIPTION OF THE DRAWINGS

FIG. 1A illustrates a top view of a razor system, according to an embodiment;

FIG. 1B illustrates a cross section view of a razor system, according to an embodiment;

FIG. 1C illustrates a view in perspective of a razor described with reference to FIGS. 1A and 1B, according to an embodiment;

FIG. 1D illustrates a view in perspective of a receptacle described with reference to FIGS. 1A and 1B, according to an embodiment;

FIG. 1E illustrates a detachable coupling between a razor head and a razor handle described with reference to FIGS. 1A and 1B in a disengaged position, according to an embodiment;

FIG. 1F illustrates a detachable coupling between a razor head and a razor handle described with reference to FIGS. 1A and 1B in an engaged position, according to an embodiment;

FIG. 2A illustrates additional details of an ejector described with reference to FIGS. 1A and 1B, according to an embodiment;

FIG. 2B illustrates a de-energized position of an ejector described with reference to FIGS. 1A and 1B, according to an embodiment;

FIG. 2C illustrates an energized position of an ejector described with reference to FIGS. 1A and 1B, according to an embodiment;

FIG. 2D illustrates additional details of an ejector fork described with reference to FIGS. 2A, 2B and 2C, according to an embodiment;

FIG. 3 illustrates a block diagram of a control system to control a razor system described with reference to FIGS. 1A, 1B, 1C, 1D, 1E, 1F, 2A, 2B, 2C and 2D, according to an embodiment; and

FIG. 4 is a flow chart illustrating a method for shaving, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements.

Similarly, the functionality of various mechanical elements, members, or components for forming modules, sub-assemblies and assemblies assembled in accordance with a structure for an apparatus may be implemented using various materials and coupling techniques, depending on the application requirements. Descriptive and directional terms used in the written description such as top, bottom, left, right, and similar others, refer to the drawings themselves as laid out on the paper and not to physical limitations of the disclosure unless specifically noted. The accompanying drawings may not to be drawn to scale and some features of embodiments shown and described herein may be simplified or exaggerated for illustrating the principles, features, and advantages of the disclosure.

As described earlier, traditional solutions to maintain the effectiveness of the cutting edge of a razor blade typically rely on the user to manually count the number of uses of the blade. More recently, techniques for counting each use of the blade are activated by a user action such as a user activating an on or off switch for an electric shaver, or a user inserting or removing a razor from a razor holder. However, such techniques for counting each use of a blade often rely on the user monitoring the counter, and such techniques may not be customizable for each user to optimize the user experience. That is, the user is typically not empowered to personalize, adapt, or adjust desired features or attributes of a safety razor to match personal preferences. Thus, use of the many of the traditional razors may degrade user's shaving experience. Therefore, a need exists for a method and system for shaving that maintains the effectiveness of the razor blade and improves the user experience. According to one embodiment, in a method and system for shaving a razor system includes a razor, a receptacle, a counter, and an ejector. The razor includes a razor handle and a razor head, the razor head being detachably coupled to the razor handle by a sliding latch. The receptacle removably houses the razor. The counter cumulatively counts each instance of a removal of the razor from the receptacle. The counter includes a comparator to compare the cumulative count to a preset count. The ejector is operable to disengage the sliding latch, thereby causing the razor head to detach from the razor handle. The ejector disengages the sliding latch in response to the cumulative count being equal to the preset count.

The following terminology may be useful in understanding the present disclosure. It is to be understood that the terminology described herein is for the purpose of description and should not be regarded as limiting.

System—One or more interdependent devices or components that cooperate to perform one or more desired functions.

Configuration—Describes a set up of an element, a device, a component, a system, and similar other, and refers to a process for setting, defining, or selecting particular properties, parameters, or attributes of the device prior to its use. Some configuration attributes may be selected to have a default or factory set value. For example, a manufacturer of a razor blade may select a default value of 8 uses for a razor blade, after which the effectiveness of the cutting edge of the razor blade may become less than desirable. A user may customize the razor by modifying or changing the initially configured value from 8 uses to 10 uses during the configuration process, based on personal preferences or previous experience. Thus, the configuration process empowers the user to customize, personalize, adapt, or adjust desired features or attributes of a device such as a safety razor to match personal preferences.

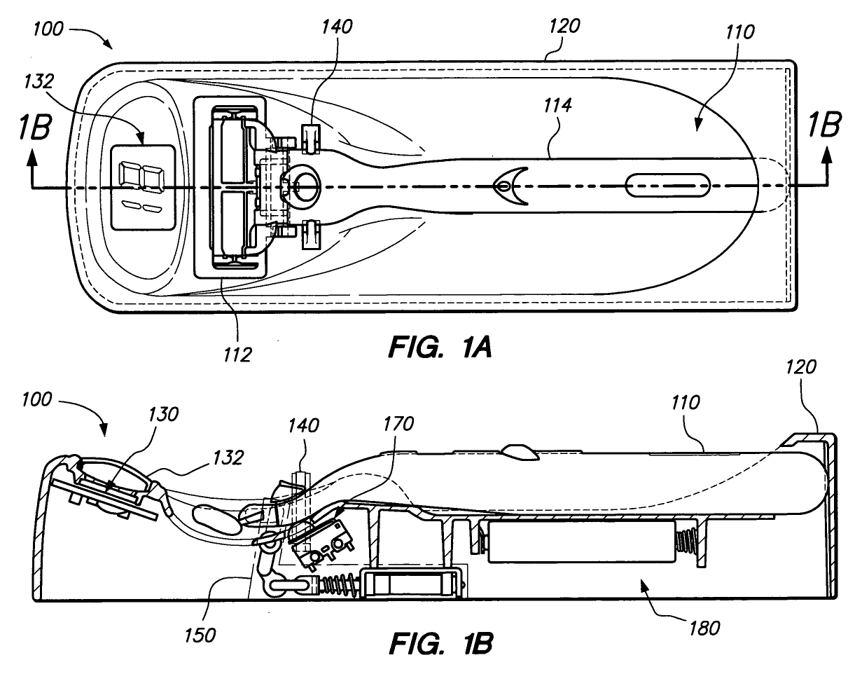

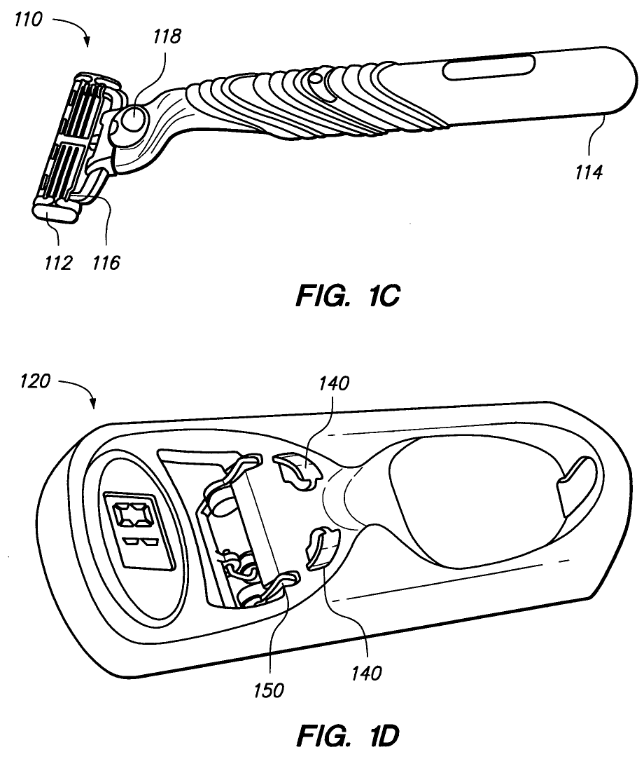

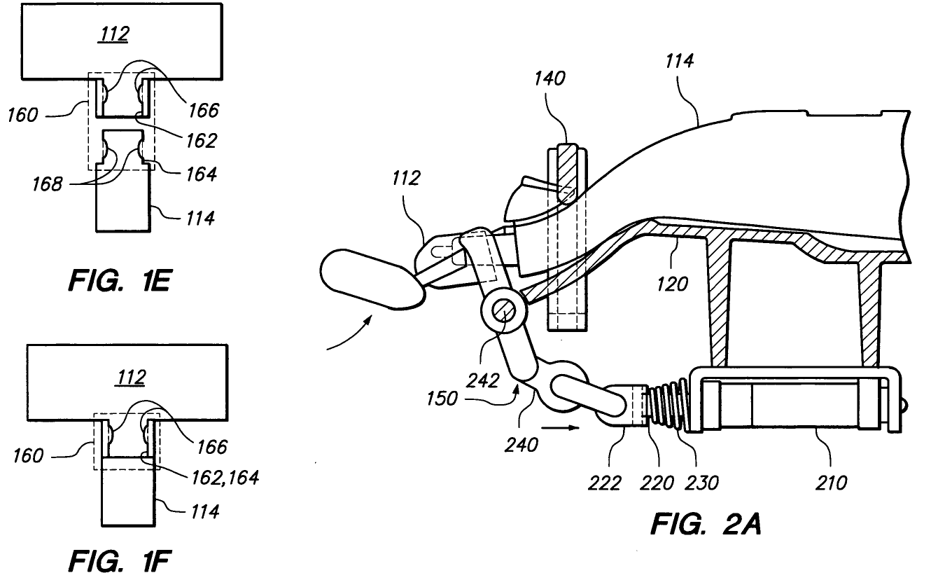

FIG. 1A illustrates a top view of a razor system 100, according to an embodiment. FIG. 1B illustrates a cross section view of the razor system 100, according to an embodiment. Referring to FIGS. 1A and 1B, the razor system 100 includes a razor 110, a receptacle 120 to house the razor 110 in a removable manner, and a counter 130 to count each instance of a removal of the razor 110 from the receptacle 120. The count is displayed on a display 132 coupled to the counter 130. In a housed position, the razor 110 is removably secured to the receptacle by a pair of clamps 140. The pair of clamps 140 is operable to flexibly open outwards when the razor 110 is removed from the receptacle 120 and to close inwards to secure the razor 110 in place when the razor 110 is placed in the receptacle 120. The razor system 100 includes a sensor 170 to detect a presence (or absence) of the razor 110 in the receptacle 120. In a particular embodiment, the sensor 170 is a limit switch, which is activated by the opening or the closing of the pair of clamps 140. In an exemplary, non-depicted embodiment, the limit switch may be activated by the placement of the razor 110 in to or out of the receptacle 120.

The razor system 100 includes an ejector 150 that is operable to automatically (and independently of a user) disengage a razor head 112 from a razor handle 114 of the razor 110 in response to configurable events such as the placement of the razor 110 into the receptacle 120, the counter 130 reaching a desired value or expiration of a time interval, e.g., 2 weeks for a new blade. A battery 180 is included in the razor system 100 to provide electrical power to the ejector 150, the sensor 170, the counter 130 and the display 132.

FIG. 1C illustrates a view in perspective of the razor 110 described with reference to FIGS. 1A and 1B, according to an embodiment. FIG. 1D illustrates a view in perspective of the receptacle 120 described with reference to FIGS. 1A and 1B, according to an embodiment. Referring to FIGS. 1C and 1D, the razor 110 includes the razor head 112 that may be detachably coupled (e.g., coupled in a detachable manner) to the razor handle 114. Additional detail of the detachable coupling between the razor head 112 and the razor handle is described with reference to FIG. 1E and FIG. 1F. The razor head 112 includes at least one razor blade 116 having a sharp cutting edge that is suitable for shaving. In the depicted embodiment, the razor head 112 includes multiple razor blades to improve the user's shaving experience compared to a razor head having a single blade. In the depicted embodiment, the razor 110 also includes an optional knob 118 that is operable to disengage or decouple the razor head 112 from the razor handle 114.

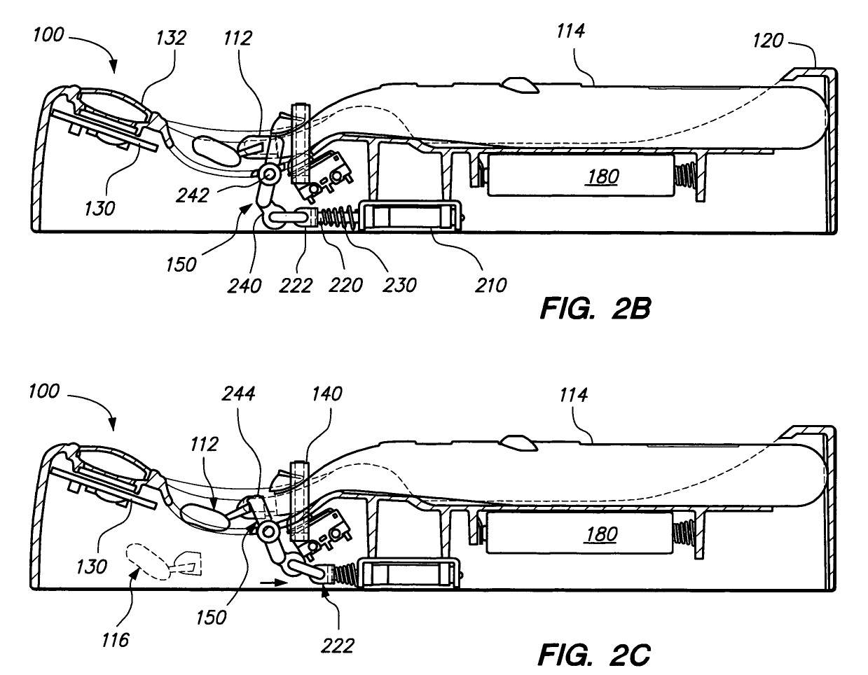

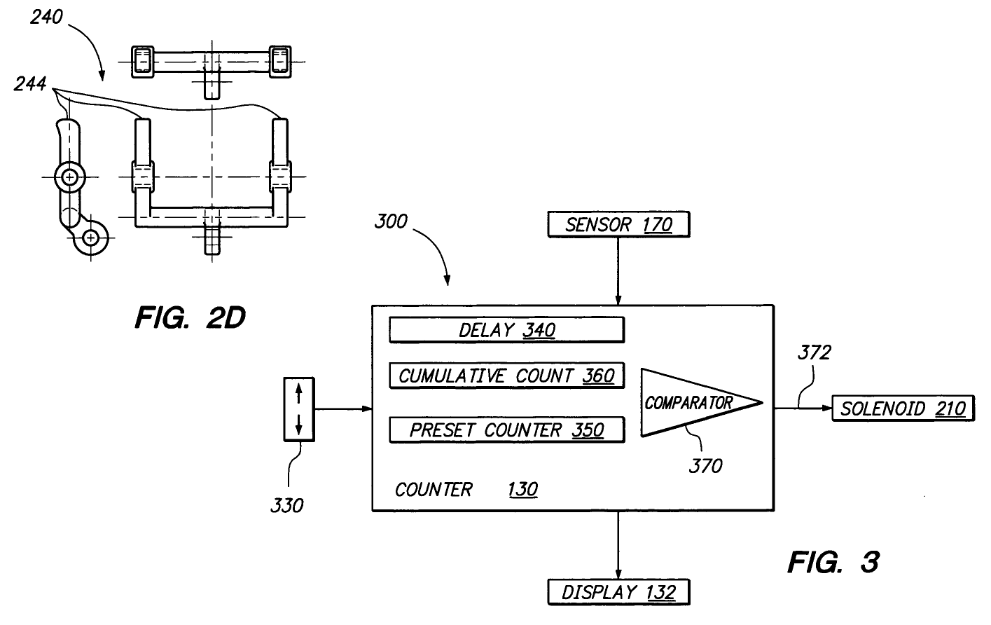

A shape of the receptacle 120 may be molded in accordance with the particular dimensions and shape of the razor 110. A partial view of the ejector 150 that is visible through an opening of the receptacle 114 to accommodate the razor head 112 is illustrated. As described earlier, the ejector 150 is operable to automatically (and independently of a user) disengage the razor head 112 from the razor handle 114. Additional detail of the ejector 150 is described with reference to FIG. 2.

FIG. 1E illustrates a detachable coupling between the razor head 112 and the razor handle 114 described with reference to FIGS. 1A and 1B in a disengaged position, according to an embodiment. FIG. 1F illustrates a detachable coupling between the razor head 112 and the razor handle 114 described with reference to FIGS. 1A and 1B in an engaged position, according to an embodiment. Referring to FIGS. 1E and 1F, in a particular embodiment, the detachable coupling between the razor head 112 and the razor handle 114 may be accomplished by using a detent mechanism that relies of spring tension. In the depicted embodiment, a sliding latch 160 is operable to engage or disengage the razor head 112 and the razor handle 114 by simply pushing or pulling an inner sleeve 162 of the razor head 112 over a matching outer surface 164 of the razor handle 114. The dimensions of the inner sleeve 162 are matched to the dimensions of the outer surface 164 for a snug fit. The sliding latch 160 includes a pair of detent tangs 166 that rely on spring tension. The pair of detent tangs 166 is located on the inner sleeve 162 protruding above the surface. The sliding latch 160 also includes a pair of recesses 168 disposed to match the pair of detent tangs 166, the pair of recesses being located on the outer surface 164. In an engaged position, the pair of detent tangs 166 protrude into the pair of match recesses 168 and exert pressure to maintain the engaged position. A pulling force of sufficient magnitude may be applied to disengage the razor head 112 from the razor handle 114.

In an exemplary, non depicted embodiment, only one detent tang and a matching recess may be deployed. It is contemplated that other detachable coupling techniques such as by use of frictional forces may also be deployed to enable engagement or disengagement by sliding. It is understood that the position of the pair of detent tangs and the pair of recesses may be reversed. That is, the pair of detent tangs may be disposed on the outer surface of the razor handle and the pair of recesses may be disposed on an inner sleeve of the razor head. Similarly, the razor head may include an outer surface that may slide into a matching inner sleeve of the razor handle.

FIG. 2A illustrates additional details of the ejector 150 described with reference to FIGS. 1A and 1B, according to an embodiment. FIG. 2B illustrates a de-energized position of the ejector 150 described with reference to FIGS. 1A and 1B, according to an embodiment. FIG. 2C illustrates an energized position of the ejector 150 described with reference to FIGS. 1A and 1B, according to an embodiment. FIG. 2D illustrates additional details of an ejector fork 240, according to an embodiment. Referring to FIGS. 2A, 2B, 2C and 2D, the ejector 150 includes a solenoid 210 having a plunger 220, a spring 230 disposed axially around the plunger 220 between the solenoid 210 and a tip 222 of the plunger, and an ejector fork 240. The ejector fork 240 is coupled to the tip 222 and is rotatable around a pivot 242 that is fixed to the receptacle 120. In a particular embodiment, when the solenoid 210 is de-energized the plunger 220 extends axially outwards due to the spring 230, thereby causing an axial motion of the tip 222 away from the solenoid 210. When the solenoid 210 is energized, e.g., receives power from the battery 180, the plunger 220 is pulled inwards along the axis, thereby causing the ejector fork 240 to rotate counterclockwise about the pivot 242. Thus, a linear motion of the plunger 220 is advantageously changed to a rotational motion of the ejector fork 240. In the de-energized position of the solenoid 210, a pair of tips 244 of the ejector fork is disposed between the razor head 112 and the pair of clamps 140. In the energized position of the solenoid 210, the pair of tips 244 exerts a pulling force of sufficient strength on the razor head 112 to cause the razor head 112 to be disengaged from the razor handle 114. The razor handle 114 is secured to the receptacle 120 by the pair of clamps 140 and is unaffected by the pulling force.

In a particular embodiment, the energizing or the de-energizing of the solenoid 210 is controlled by the counter 130. Thus, the ejector 150 is operable to disengage the sliding latch 160 in response to the counter 130 having a desired value. The razor head 112 that has been automatically disengaged by the ejector 150 is collected in the receptacle 120 for proper disposal. A new razor head may be attached to the razor handle 114 and the counter 130 reset to start a new shaving cycle. The display 132 may be configured to display a default number of uses for the new blade. Additional detail of a control system to automatically eject a razor head is response to configurable events is described with reference to FIG. 3.

FIG. 3 illustrates a block diagram of a control system 300 to control the razor system 100 described with reference to FIGS. 1A, 1B, 1C, 1D, 1E, 1F, 2A, 2B, 2C and 2D, according to an embodiment. The control system 300 includes the counter 130, a user input 310 electrically coupled to the counter 130, the sensor 170 electrically coupled to the counter 130, and the solenoid 210 electrically coupled to the counter 130. The control system 300 controls the automatic disengagement of the razor head 112 from the razor handle 114 based on configurable events such as count values, elapsed time interval, presence or absence of a razor in a receptacle, and similar others. The display 132 displays an alphanumeric value that is output by the counter 130. In an embodiment, the display 132 is selectable to be one of an electronic display, e.g., a liquid crystal display (LCD) or a light emitting diode (LED) display, and a mechanical display, e.g., a mechanical odometer type display.

The configuration of the razor system 100 includes defining a desired number of uses of the razor head 112 during which the effectiveness of the razor blade is maintained within an acceptable level of performance. The desired number of uses of the razor head 112 may be factory set and stored in the counter 130 as a preset count 350, which may be modified by a user based on personal preferences. A user input 330 is used to receive a user input to configure the razor system 100. In the depicted embodiment, the user input 330 includes an up/add button and a down/subtract button to modify the preset count 350. The sensor 170 detects a change of state (e.g., change of state from housed state to not housed state or from not housed state to housed state) of the housing status of the razor 110 in the receptacle 120. Since the razor 110 is initially housed in the receptacle 120 each instance of a removal of the razor 110 may be indicative of its use. The counter 130 is operable to count each instance of the removal and store a cumulative count 360 of the total number of removal instances of the razor 110 from the receptacle 120. A comparator 370 is operable to compare the values of the preset count 350 and the cumulative count 360, and if they are equal, energize the solenoid 210. In an embodiment, the counter 130 verifies the presence of the razor 110 in the receptacle 120 and then outputs a trigger signal 372 to energize the solenoid 210. It is understood that the output of the trigger signal 372 may also be configured to be based on events such as after expiration of a preferred time duration for a new blade. That is, the automatic disengagement of the razor head 112 may be based on timed events, in addition to or in lieu of the number of uses. As described earlier, the solenoid 210 upon being energized automatically disengages the razor head 112 from the razor handle 114.

In an alternative embodiment, the preset count 350 is set initially to the desired number of uses of the razor head 112. Each instance of a use of the razor head 112 is decremented from the preset count 350 and the solenoid 210 is energized when the preset count 350 is equal to zero. The display 132 is updated to indicate the value of the preset count 350. In this embodiment, the comparator 370 is operable to compare the value of the preset count 350 to a fixed value of zero.

In an embodiment, a delay 340 may be included to filter out undesired or accidental removals of the razor 110, e.g., by not counting a removal if the razor 110 is re-installed in the receptacle 120 within time period t, which is set to be much less than the average shaving time. In an embodiment, the counter 130 is operable to generate an alarm, e.g., by a blinking or flashing display, to indicate the disengagement of the razor head 112 or indicate a malfunction of the razor system 100 by displaying an error code on the display 132.

As described earlier, it is understood that one or more components of the control system 300 described herein may be implemented as hardware (including discrete components, integrated circuits and systems-on-a-chip ‘SOC’), firmware (including application specific integrated circuits and programmable chips) and software or a combination thereof, depending on the application. In a particular embodiment, the counter 130 may be implemented by a field programmable gate array (FPGA).

In an embodiment, the solenoid 210 may be manufactured by BICRON Electronics Company (“BICRON”) located at 50 Barlow Street, Canaan, Conn. 06018. The part number for the pull type open frame solenoid is SC0323N. In an exemplary, non-depicted embodiment, a capacitive-discharge circuit, similar to one commonly found in photo strobe light firing circuits, may be used to increase the amount of electrical power available to the solenoid 210. In this embodiment, the trigger signal 372 may be used to trigger the capacitive-discharge circuit.

In an embodiment, certain functions of the control system 300 may be bypassed or disabled by a user. For example, the counter 130 may be disabled to count the removal instances, thereby disabling the automatic disengagement of the razor head 112. In an embodiment, the user may disable automatic control and manually direct the control system 300 to perform particular actions, e.g., forcing the solenoid 210 to be energized, thereby disengaging the razor head 112 from the razor handle 114.

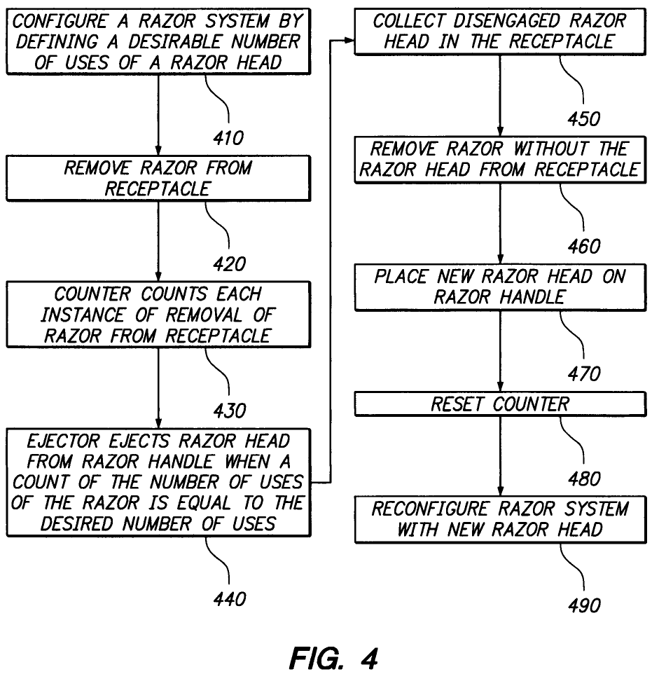

FIG. 4 is a flow chart illustrating a method for shaving, according to an embodiment. In a particular embodiment, the method for shaving is performed by using the shaving system 100 described with reference to FIGS. 1A, 1B, 1C, 1D, 1E, 1F, 2A, 2B, 2C, 2D, and 3. At step 410, a razor system is configured by defining a desirable number of uses of a razor blade included in a razor head. The razor system includes a razor capable of being house in a receptacle, a counter and an ejector. The razor includes a razor head having at least one razor blade, the razor head being detachably coupled to a razor handle. At step 420, the razor is removed from the receptacle to perform the shaving. At step 430, each use of the razor as measured by each instance of a removal of the razor from the receptacle is counted by the counter. At step 440, the ejector ejects the razor head from the razor handle by disengaging a sliding latch when a count of the number of uses of the razor is equal to the desirable number of uses of the razor blade, and hence of the razor head. At step 450, the disengaged razor head 116 is collected into the receptacle for proper disposal. At step 460, the razor without the razor head is removed from the receptacle. At step 470, a new razor head is placed on the razor handle. At step 480, the counter is reset. At step 490, the razor system with the new razor head is reconfigured.

Various steps described above may be added, omitted, combined, altered, or performed in different orders. For example, step 410 may be omitted if the user preference for the desired number of uses of the razor head is equal to the initial factory setting.

Several advantages are achieved by the method and system according to the illustrative embodiments presented herein. The embodiments advantageously provide an improved shaving system that is capable of empowering a user to define desirable number of shaves for each blade before it is replaced. The improved razor system provides automatic tracking for the number of uses of the razor blade. In addition, the razor system also provides automatic ejection of the razor blade when the number of uses of the razor blade is equal to the desirable number of shaves for the razor blade. The razor system thus automatically ensures an acceptable level of sharpness of the razor blade, thereby improving the users shaving experience.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. For example, it should be understood that while the disclosure described a razor system having electrical or electronic components, it would be within the spirit and scope of the invention to encompass an embodiment deploying mechanical components within the razor system to perform the same or similar functions.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A razor system comprising:
a razor having a razor handle and a razor head, the razor head being detachably coupled to the razor handle by a sliding latch;
a receptacle to removably house the razor;
a counter to count each instance of a removal of the razor from the receptacle in a cumulative count, the counter having a comparator to compare the cumulative count to a preset count; and
an ejector to disengage the sliding latch, thereby causing the razor head to detach from the razor handle, wherein the ejector disengages the sliding latch in response to the cumulative count being equal to the preset count.

2. The razor system of claim 1, wherein the ejector includes:
a solenoid having a plunger, the plunger capable of an axial motion in response to a trigger by the counter;
a spring disposed axially around the plunger to oppose the axial motion; and
an ejector fork coupled to the plunger, the ejector fork being operable to detach the razor head from the razor handle in response to the axial motion.

3. The razor system of claim 1, wherein the sliding latch includes:
a pair of detent tangs located on an inner sleeve of the razor head; and
a pair of recesses disposed to match the pair of detent tangs, thereby detachably coupling the razor head and the razor handle, the pair of recesses being located on an outer surface of the razor handle, wherein dimensions of the inner sleeve are matched to fit the outer surface.

4. The razor system of claim 1, wherein the sliding latch includes:
a pair of detent tangs located on an outer surface of the razor handle; and
a pair of recesses capable of mating with the pair of detent tangs to detachably couple the razor head to the razor handle, the pair of recesses being located on an inner sleeve of the razor head, wherein dimensions of the inner sleeve are matched to fit the outer surface.

5. The razor system of claim 1, wherein the preset count is set as a default value, wherein the default value is modifiable by a user.

6. The razor system of claim 1, wherein the counter includes an increase button and a decrease button operable to modify the preset count.

7. The razor system of claim 1, wherein, the preset count is configurable by a user, wherein the preset count is indicative of a maximum number of uses of the razor head by the user.

8. The razor system of claim 1, wherein the razor head includes at least one blade.

9. The razor system of claim 1 further comprising:
a sensor coupled to the counter to detect a presence of the razor in the receptacle;
a delay to detect placement of the razor in the receptacle without use of the razor; and
a display to display the cumulative count.

10. The razor system of claim 9, wherein the display is selectable to be one of an electronic display and a mechanical display.

11. The razor system of claim 9, wherein the delay is configurable by a user.

12. The razor system of claim 1, wherein the ejector is operable to be bypassed, thereby disabling the ejector to disengage the sliding latch.

13. The razor system of claim 1, wherein the counter is operable to be bypassed, thereby disabling the counter to count.

14. The razor system of claim 1, wherein the counter generates an alarm in response to the cumulative count being equal to the preset count.

15. The razor system of claim 1, wherein the counter provides a trigger to the ejector in response to the cumulative count being equal to the preset count, wherein the trigger causes a rotational movement of the ejector, the rotational movement causing disengagement of the razor head from the razor handle.

16. A method for shaving, the method comprising:
configuring a razor system having a razor, a counter, an ejector, and a receptacle, wherein the razor includes a razor head detachably coupled to a razor handle by a sliding latch, wherein the ejector is operable to disengage the sliding latch, wherein the receptacle removably houses the razor, wherein the configuring includes defining a desirable number of uses of the razor head;
removing the razor from the receptacle to perform the shaving;
counting each use of the razor by the counter; and
ejecting the razor head from the razor handle by disengaging the sliding latch, the ejecting being performed by the ejector when a count of the number of uses of the razor is equal to the desirable number of uses of the razor head.

17. The method of claim 16 further comprising:
collecting the razor head disengaged from the razor handle into the receptacle.

18. The method of claim 16 further comprising:
removing the razor from the receptacle;
replacing the razor head disengaged from the razor handle with a new razor head;
resetting the counter; and
reconfiguring the razor system.

19. A razor system comprising:
means for configuring a razor system having a razor removably housed in a receptacle, wherein the razor includes a razor head detachably coupled to a razor handle, wherein the means for configuring includes means for defining a desirable number of uses of the razor head;
means for removing the razor from the receptacle;
means for counting each use of the razor; and
means for ejecting the razor head from the razor handle when a count of the number of uses of the razor is equal to the desirable number of uses of the razor head.

20. The razor system of claim 16 further comprising:
means for replacing the razor head ejected from the razor handle with a new razor head.
